(19) United States
(12) Patent Application Publication
(10) Pub. No.: US 2001/0046571 A1
(43) Pub. Date: Nov. 29, 2001

(54) DECORATIVE ARTICLES

(76) Inventor: GADI EISNER, DENVER, CO (US)

Correspondence Address: GLENN L WEBB, P.O. BOX 951, CONIFER, CO, 80433

(21) Appl. No.: 09/244,006

(22) Filed: Feb. 4, 1999

(51) Int. Cl. B44F 7/00; A44C 15/00; A46B 15/00

(52) U.S. Cl. 428/15; 15/159.1; D04/124; D04/126; D04/138; 63/40

(57) ABSTRACT

Unique designs are associated with articles of personal use, such as hairbrushes, hand mirrors, jewelry and the like. The unique designs include creating unusual three-dimensional faces on the articles to associate characters with the articles. The characters are given names and storylines to create unique identities for the articles.

### FIELD OF THE INVENTION

This invention relates to the field of decorative articles, and particularly to the field of decorative articles for personal use.

### BACKGROUND OF THE INVENTION

Articles for personal use, such as hairbrushes, hand mirrors, hair ornaments, jewelry and other articles occasionally have ornamental designs applied to them. These designs tend to be two-dimensional appliques, such as names, or artwork. These articles are relatively impersonal and utilitarian in nature. There has been no attempt previously to provide these articles with a sense of uniqueness or “identity”.

One example of the prior ornamental articles for personal use is disclosed in U.S. Pat. No. 3,634,178, issued to Goodman. This patent discloses mounting decorative appliques, such as alphabetic characters, to articles, such as rings, barrettes or hairbrushes to form a monogram on the article. However, these appliques do not provide a sense of uniqueness to the article itself, but are intended to form alphabetic names or initials on the article.

There have been previous uses of providing unique identities to other products, such as with certain collectable dolls. These collectable dolls are provided with a name and a history. Thus, a unique character is associated with a particular doll. Examples of these dolls include the Cabbage Patch Kids® dolls by Mattel, Inc. and Beenie Babies® by Ty, Inc. Prior to the present invention, such unique identities have not been applied to articles of personal use, such as hairbrushes, combs, hand mirrors, jewelry, and other such articles.

The prior art articles for personal use do not provide such a unique identity to these types of articles. Further, the prior articles do not provide stylized and unique articles of personal use. There presently is an interest and demand for such articles, as provided by the present invention.

### SUMMARY OF THE INVENTION

The present invention solves this demand by providing unique articles for personal use, such as hairbrushes, hand mirrors, jewelry and other personal articles. One embodiment of the present invention is applied to articles such as a hairbrush or hand mirror having a handle and head assembly. The head assembly includes a working surface, such as a set of bristles or mirror surface and a decorative surface.

The decorative surface includes a unique design that provides an “identity” associated with the article.

In one preferred embodiment, a face is formed on the article to provide a unique character associated with the article. The character is given a name and a storyline to create an identity to this character. A series of characters can thus be created for different articles. In a particular embodiment, the face is created by using three-dimensional components, such as the eyes, nose and mouth of the character. Bright colors and designs can also be used to create unusual and unique characters. The articles, such as hairbrushes, can be collected as a group or individually.

Other preferred embodiments include associating historical, mythical, theatrical, fictional or television characters with the articles by using appropriate character faces or figures on the articles. Holiday characters or scenes can also be created on the articles. Licensed characters may also be used, in connection with ongoing movie, theatrical or television programs for promotional purposes.

Stylized designs, such as three-dimensional geometric shapes and colors, can also be formed on the articles to create unique articles in additional embodiments.

These and other features of the claimed inventions will be evident from the detailed description of preferred embodiments in conjunction with the drawings.

### BRIEF DESCRIPTION OF THE DRAWINGS

FIG. 1 is an illustration of a preferred embodiment of the present invention with a three-dimensional face on a hairbrush.

FIG. 2 is an illustration of a second three-dimensional face on a hairbrush in the preferred embodiment of the present invention.

FIG. 3 is an illustration of a third three-dimensional face on a hairbrush in the preferred embodiment of the present invention.

FIG. 4 is an illustration of three-dimensional face on a hand mirror in the preferred embodiment of the present in invention.

FIG. 5 is the mirror surface of the hand mirror of FIG. 4.

FIG. 6 is a vignette associated with the embodiment of FIG. 1.

### DETAILED DESCRIPTION OF A PREFERRED EMBODIMENT

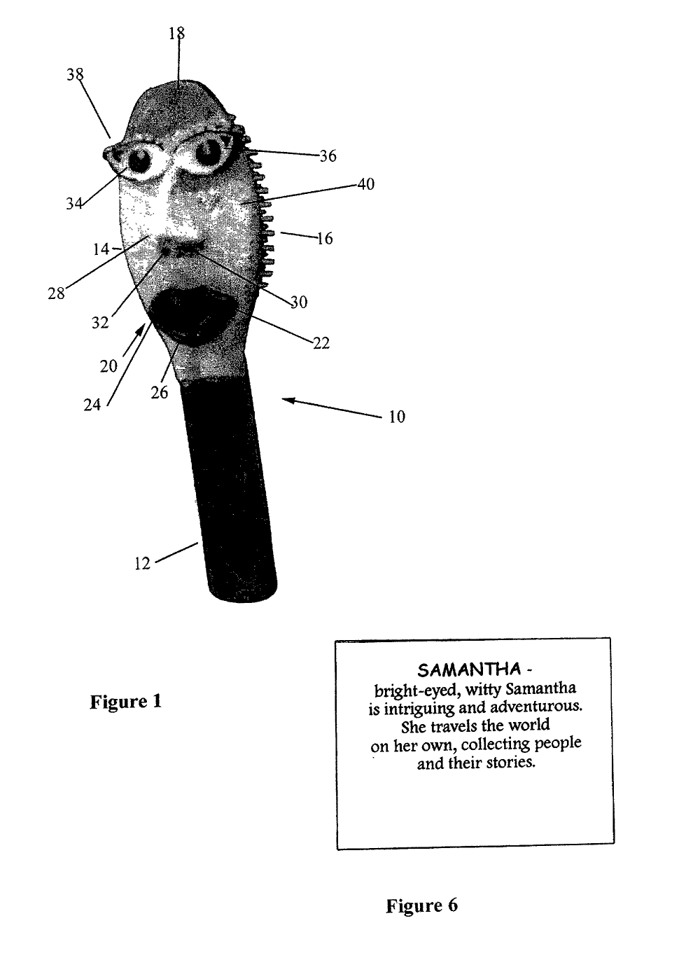

The present invention provides unique decorative designs onto articles of personal use. Descriptive embodiments of the present invention are illustrated in FIGS. 1-6 for explanatory purposes. It is to be expressly understood that the scope of the present invention is not these descriptive embodiments, but other embodiments are considered to be within the claimed inventions.

The embodiment of the present invention illustrated in FIG. 1 includes a hairbrush 10 having a handle 12 and a head assembly 14. While this particular embodiment is described for use with a hairbrush, other articles could be used as well as discussed further below. The head assembly 14 of the hairbrush 10 includes a set of bristles 16 and a back surface 18. A face 20 is formed on the back surface 18 of the hairbrush. In this particular embodiment, the face 20 is formed by three-dimensional components. The three-dimensional face 20 is that of a whimsical character. The face 20 includes a mouth 22 having distinctive lips 24, 26, a nose 28 having nostrils 30, 32 and eyes 34, 36. This particular face 20 also includes eyeglasses 38. A series of ornamental designs 40 also decorate the face 20 as well. Another feature of the present invention is to use bright colors with the face 20 as well. The distinctive face 20 creates a unique character on the decorative article.

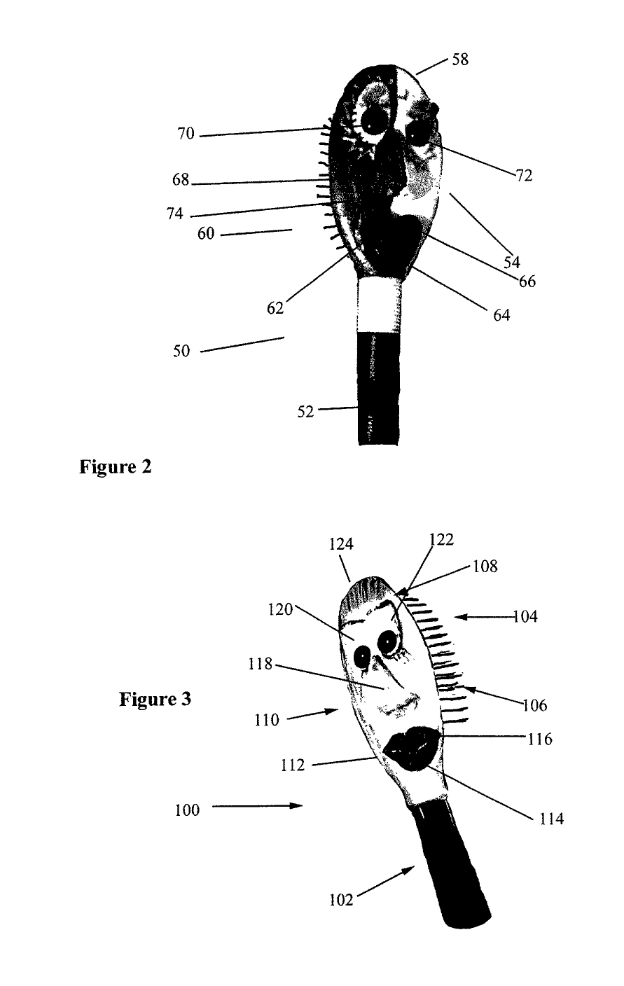

Another embodiment of the present invention is illustrated in FIG. 2. This embodiment is also included on a hairbrush, although other articles could be used as well. This hairbrush 50 also includes a handle 52 and a head assembly 54. The head assembly 54 includes a set of bristles 56 and a back surface 58. Another distinctive three-dimensional face 60 is formed on the back surface 58 of the head assembly 54. This distinctive face 60 also includes a mouth 62 having lips 64, 66, a nose 68 and eyes 70, 72. Ornamental designs 74 also are provided to give the face 50 a distinctive character. Also, the use of bright colors with the face 50, not clearly shown in the drawings, adds further eye appeal to the articles.

A third example of the unique characters formed on the articles is shown in FIG. 3. Again, the hairbrush 100 includes a handle 102 and a head assembly 104. The head assembly 104 includes a set of bristles 106 and a back surface 108. Another distinct face 110 is formed on the back surface 108 of the hairbrush assembly. A mouth 112 with lips 114, 116, a nose 118, eyes 120, 122 and hair 124 create a distinctive face 110 to create yet another unusual character associated with the article 100.

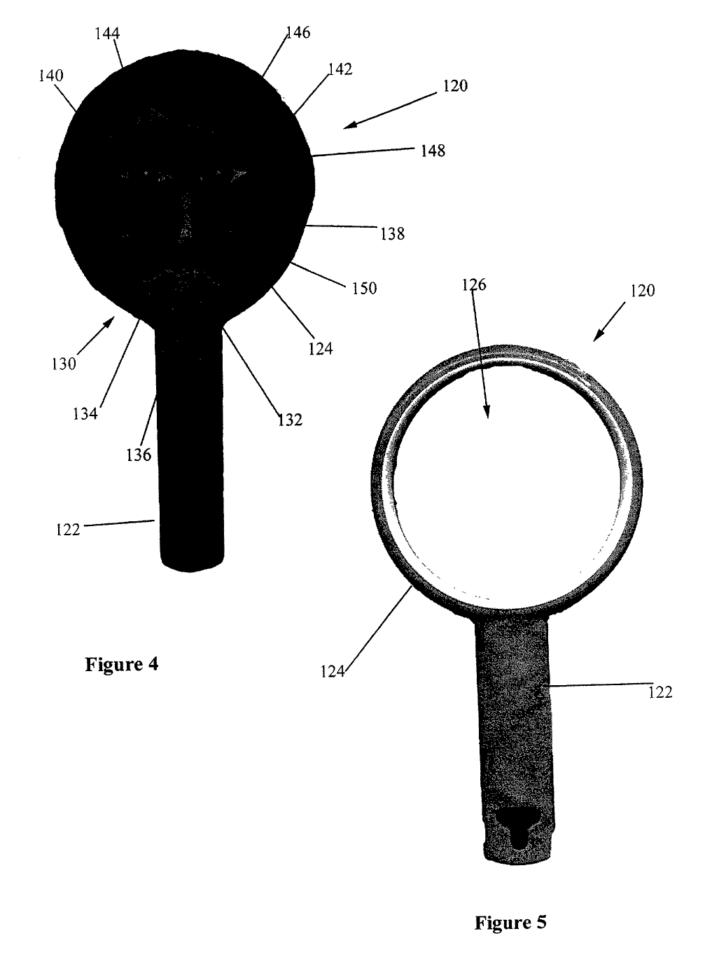

These whimsical and unusual faces create distinctive characters associated with the articles. It is to be expressly understood that while these particular embodiments utilize three-dimensional faces, two-dimensional characters could also be used as well. These characters provide unique “identities” to the articles themselves. While these faces and characters are discussed above formed on hairbrushes, other articles may be used as well. For example, as shown in FIGS. 4 and 5, a hand mirror 120 includes a handle 122 and mirror assembly 124. The mirror assembly includes a mirror 126 on a back surface with a distinctive face 130 on the back surface of the mirror assembly 124. The mirror face 130 includes a mouth 132 having lips 134, 136, a nose 138, eyes 140, 142, eyebrows 144, 146, a distinctive hairstyle 148 and decorations 150. These three-dimensional features provide a distinctive face of an unusual and unique character.

Other articles can be used as well. For example, and without limiting the claimed inventions, hair ornaments, such as barrettes, clasps and the like, jewelry, boxes, and other personal articles may be used as well. Also, two-dimensional faces could be formed on the articles as well.

Another feature of the present invention is to provide a name and identity for each of the characters. For instance, the character represented by the face 20 on the hairbrush 10 in the embodiment illustrated in FIG. 1 will have a name, such as “Samantha”. A vignette, such as shown in FIG. 6, will be included with the hairbrush 10 will provide a storyline about the character Samantha. This storyline may include the personal history of this whimsical character as well as hints about the personality traits of this character, stories about her life and other details which will create a unique character. Other names and storylines can be associated with other characters, such as the characters represented in the embodiments of FIGS. 2-5.

The present invention may also group series of these articles and the characters they represent into “families”. Thus, these articles will become “collector” items and their intrinsic value will be increased.

Other embodiments of the present invention include creating sports figures on the articles, as well as representing particular sports as well. For example, three-dimensional baseball figures may be represented on the surface of some articles or an actual three-dimensional representation of a baseball might be affixed onto the surface of an article. Other sports and sports figures can be used as well.

Another embodiment is to provide three-dimensional animal characters on the surface of articles. Yet another embodiment is to create three-dimensional representations of historical figures, fictional heroes, and/or other mythical or religious figures on the articles. A series of licensed characters could also be created in connection with ongoing movie or theatrical releases, television program characters, and comic or cartoon characters.

Another embodiment of the present invention is to provide three-dimensional figures or characters on the articles in connection with holidays. For example, a Santa Clause character could be utilized as a Christmas gift. Other holidays could be represented by other characters. Religious figures, where appropriate, may be used as well.

Another embodiment of the present invention is to use three-dimensional geometric shapes to create unusual articles with eye appeal. Distinctive colors can be utilized along with these shapes to create an unusual article. Also, other designs can be used to create stylized articles, such as Art Deco style articles.

Another embodiment of the present invention is to provide a “kit” of the components of the designs that a user can utilize to create their own unique designs on their personal articles. The kit can be used as a craft type project to enable users to personalize their own articles or to create unique article designs for gifts.

As can be ascertained from the above discussion, the present invention encompasses providing designs onto articles for personal use to create a unique identity to the articles. One particular embodiment includes providing three-dimensional designs on the articles. Another embodiment includes the use of unusual faces formed on the articles along with names and a storyline to create a unique character associated with the articles.

The present invention, as set forth in the claims, is not intended to be unduly limited by the discussion of preferred embodiments. Other embodiments and variations are considered to be within the scope of the invention as set forth in the claims.

What is claimed is:

1. An article of personal use, said article comprising:
at least one surface for ornamentation; and
a three-dimensional design affixed to said at least one surface.

2. The article of claim 1, wherein said article includes:
a hairbrush.

3. The article of claim 1, wherein said article includes:
a hand mirror.

4. The article of claim 1 wherein said article includes:
an article of jewelry.

5. The article of claim 1 wherein said three-dimensional design includes:
a unique character face.

6. The article of claim 1 wherein said article further includes:
said three-dimensional design includes a face representing a unique character; and
a name associated with said unique character.

7. The article of claim 1 wherein said article further includes:
said three-dimensional design includes a face representing a unique character; and
a name associated with said unique character; and a vignette describing a story about said unique character.

8. The article of claim 1 wherein said three-dimensional design includes:
animal faces.

9. The article of claim 1 wherein said three-dimensional design includes:
representations of sports.

10. The article of claim 1 wherein said three-dimensional design includes:
representations of actual people.

11. The article of claim 1 wherein said three-dimensional design includes:
representations of mythical characters.

12. The article of claim 1 wherein said three-dimensional design includes:
fanciful designs.

13. The article of claim 1 wherein said three-dimensional design includes:
components which can be mounted on the article by the user.

14. An article for personal use, said article comprising:
at least one surface for ornamentation; and
a three-dimensional design affixed to said at least one surface to provide a unique identity to said article.

15. The article of claim 14 wherein said three-dimensional design includes:
means for creating a face of a unique character.

16. The article of claim 14 wherein said three-dimensional design includes:
means for creating a face of a unique character; and
a name associated with said unique character.

17. The article of claim 14 wherein said three-dimensional design includes:
means for creating a face of a unique character;
a name associated with said unique character; and
a vignette describing a story about said unique character.

18. The article of claim 15 wherein said means for creating a face of a unique character includes:
components which can be applied onto the article by a user.

19. An article of personal use, said article comprising:
at least one surface for ornamentation; and
a face formed on said at least one surface.

20. The article of claim 19, wherein said article further includes:
a name associated with said face.

21. The article of claim 19, wherein said article further includes:
a name associated with said face; and
a storyline associated with said face.

22. The article of claim 19 wherein said face includes:
a three-dimensional face.
